(19) United States
(12) Patent Application Publication
(10) Pub. No.: US 2026/0346435 A1
(43) Pub. Date: Nov. 5, 2026

(54) SCALABLE NEURAL CONTROL FOR DEXTEROUS MANIPULATION FROM REFERENCE-SCOPED EXPLORATION

(71) Applicant: NVIDIA Corporation, Santa Clara, CA (US)

(72) Inventors: Sirui Xu, Urbana, IL (US); Wei Yang, Lake Forest Park, WA (US); Yu-Wei Chao, Redmond, WA (US); Arsalan Mousavian, Seattle, WA (US)

(21) Appl. No.: 19/391,525

(22) Filed: Nov. 17, 2025

Related U.S. Application Data
(60) Provisional application No. 63/797,946, filed on Apr. 30, 2025.
(60) Provisional application No. 63/798,706, filed on May 2, 2025.

(51) Int. Cl. B25J 9/16

(52) U.S. Cl. CPC B25J 9/163; B25J 9/1697; G05B 2219/33034; G05B 2219/39001

(57) ABSTRACT

Apparatuses, systems, and techniques for obtaining a robot control policy. In an embodiment, a first policy is trained to generate an action sequence based on a reference demonstration that provides, for one or more time steps, reference states of a human hand and an object. The training includes obtaining the reference demonstration, generating, for the one or more time steps, a sequence of actions for controlling a robot end effector to interact with the object, computing, based on the sequence of actions and the reference states, one or more rewards, and updating parameters of the first policy based on the one or more rewards. The rewards are computed based on an anatomy mapping between the human hand and the robot end effector and one or more spatial envelopes for the robot end effector. A second policy is trained, using the first policy, to generate robot actions based on perception data.

### CLAIM OF PRIORITY

This application claims the benefits of U.S. Provisional Application No. 63/797,946, filed Apr. 30, 2025, and U.S. Provisional Application No. 63/798,706, filed May 2, 2025, the entire contents of which are incorporated herein by reference.

### BACKGROUND

Achieving human-level dexterity remains a fundamental and long-standing challenge in robotics and autonomous systems, with far-reaching implications for tasks ranging from object sorting and packaging to food preparation and assisted living. Despite decades of research, robotic dexterous manipulators continue to struggle with many tasks that humans perform with ease, highlighting the persistent gap between the dexterous manipulation capabilities of humans and robots.

Several key factors contribute to the difficulty of learning dexterous manipulation from humans. Human hands possess an unparalleled combination of kinematic complexity, compliance, and rich tactile sensing. In contrast, robotic hands often have substantially different morphologies, fewer effective degrees of actuation, and limited sensing and force control capabilities. This mismatch renders direct knowledge transfer inherently challenging. To address this, existing approaches typically retarget human demonstrations onto robot anatomy, as tracked by a low-level controller, and often employ corrective strategies to compensate for tracking errors and anatomical mismatches. However, errors introduced during retargeting can compound, negatively impacting policy learning. For instance, a grasp that appears feasible for a human hand may be infeasible or highly suboptimal for a humanoid robot hand when, e.g., enforcing precise fingertip matching.

### BRIEF DESCRIPTION OF THE DRAWINGS

The present systems and methods for scalable neural control for dexterous manipulation from reference-scoped exploration are described in detail below with reference to the attached drawing figures, wherein:

FIG. 1A illustrates a first model, according to one or more embodiments of the present disclosure.

FIG. 1B illustrates a second model, according to one or more embodiments of the present disclosure.

FIG. 2A illustrates an example architecture for training a state-based imitation policy, according to one or more embodiments of the present disclosure.

FIG. 2B illustrations an example process for training a state-based imitation policy, according to one or more embodiments of the present disclosure.

FIG. 3A illustrates an example architecture for training a vision-based generative control policy, according to one or more embodiments of the present disclosure.

FIG. 3B illustrates an example process for generating a point cloud-based representation based on a privileged object positioning, according to one or more embodiments of the present disclosure.

FIG. 3C illustrates an example process for training a vision-based generative control policy, according to one or more embodiments of the present disclosure.

FIGS. 3D and 3E show example simulation results compared with other models, according to one or more embodiments of the present disclosure.

FIG. 3F illustrates additional simulation results, according to one or more embodiments of the present disclosure.

FIG. 4 illustrates an example parallel processing unit (“PPU”), suitable for use in implementing one or more embodiments.

FIG. 5A illustrates a processing system, implemented using the PPU of FIG. 4, suitable for use in implementing one or more embodiments.

FIG. 5B illustrates an example system in which various architectures and/or functionality may be implemented, according to one or more embodiments.

FIG. 5C illustrates an example system suitable for training and utilizing a machine learning model, according to one or more embodiments.

FIG. 6 illustrates an example streaming system, suitable for use in implementing one or more embodiments.

### DETAILED DESCRIPTION

Systems and methods are disclosed herein for obtaining a vision-based robot control policy from human demonstrations, using a training paradigm that first learns a state-based imitation policy and subsequently learns a vision-based policy by leveraging the knowledge acquired from the state-based imitation policy.

In at least one embodiment, the state-based imitation policy acquires scalable dexterous manipulation skills by leveraging adaptive contact bounds from human demonstrations, shifting from rigid trajectory replication to flexible, energy-based guidance tailored to the robot's morphology. Subsequently, the learned state-based imitation policy from the first stage is distilled and utilized for training the vision-based generative control policy.

This training stage eliminates reliance on privileged object observations and dense human references, supporting potential simulation-to-reality transfer.

Accordingly, the training paradigm employs a unified, single-loop optimization that integrates retargeting and tracking to train a scalable robot control policy directly from large, contact-rich datasets such as hand-object motion-capture (MoCap) repositories, facilitating reference-scoped exploration (RSE). In contrast to existing pipelines that rely on a three-stage workflow-including retargeting, tracking, and residual correction- and treat demonstrations as strict ground truth, the present approach provides soft guidance during training. This distinct strategy enables the construction of adaptive spatial scopes from raw demonstrations, defining time-varying termination boundaries within which reinforcement learning encourages the policy to remain while minimizing control effort. The holistic framework preserves the intent of the demonstrations, allows robot-specific strategies to emerge, enhances robustness to noise, and scales effectively with large-scale demonstration data. The learned state-based imitation policy (e.g., a scaled tracking policy) is further distilled into a vision-based, skill-conditioned generative control policy that captures diverse manipulation skills within a rich latent representation, enabling generalization across various objects and real-world robotic manipulation tasks.

A method is provided for obtaining a robot control policy, which includes: training a first policy to generate an action sequence based on a reference demonstration that provides, for one or more time steps, reference states of a human hand and an object, and training, using the first policy, a second policy to generate robot actions based on perception data. In at least one embodiment, training the first policy includes: obtaining the reference demonstration, generating, by the first policy for the one or more time steps, a sequence of actions for controlling a robot end effector to interact with the object, computing, based on the sequence of actions and the reference states, one or more rewards, and updating parameters of the first policy based on the one or more rewards. The rewards are computed based on a mapping between an anatomy of the human hand and an anatomy of the robot end effector and one or more spatial envelopes for one or more anatomical components of the robot end effector.

According to one or more embodiments of the method, training the first policy also includes: receiving initial states of the robot end effector and object corresponding to the reference demonstration, and initializing the robot end effector and the object using the initial states.

According to one or more embodiments of the method, the first policy is trained over a plurality of episodes to generate a plurality of action sequences based on the reference demonstration. In at least one embodiment, at the start of each episode of the plurality of episodes, the robot end effector and the object are initialized using the initial states.

According to one or more embodiments of the method, one or more episodes of the plurality of episodes are terminated. In at least one embodiment, each terminated episode is terminated when the one or more rewards satisfy one or more early termination conditions.

According to one or more embodiments of the method, in at least one episode of the plurality of episodes, the one or more early termination conditions are initialized with a large value and adaptively tightened during training.

According to one or more embodiments of the method, the one or more rewards include a state-reference matching reward and an energy regularization reward. The state-reference matching reward corresponds to kinematic state matching based on distances between the robot end effector and the object and one or more tactile indicators corresponding to contacts between the robot end effector and the object. The energy regularization reward corresponds to smoothness of robotic motions induced by the first policy.

According to one or more embodiments of the method, training the first policy also includes obtaining, for the one or more time steps, one or more states of the robot end effector and the object by applying the sequence of actions to control the robot end effector. In at least one embodiment, computing the one or more rewards is further based on the one or more states of the robot end effector and the object and the reference states at the one or more time steps.

According to one or more embodiments of the method, the perception data includes a partial observation of the robot end effector and the object and a predefined goal that defines a robot manipulation task.

According to one or more embodiments of the method, the second policy is learned by a model including a prior network configured to encode the perception data to sample a latent representation from a latent space and a decoder network configured to decode the sampled latent representation into an action sequence.

According to one or more embodiments of the method, training the second policy includes: encoding, using an encoder, a plurality of reference demonstrations to produce a reference latent space comprising a plurality of latent representations, the reference latent space associated with a reference latent representation distribution, generating, by the first policy, a reference action sequence corresponding to a given reference trajectory, sampling, using the prior network and based on the perception data, a latent representation from a latent space of the prior network, wherein during training, the latent space of the prior network is compensated using the reference latent representation distribution of the reference latent space, decoding, using the decoder network, the sampled latent representation to generate a predicted action sequence, computing a loss between the reference action sequence and the predicted action sequence, and updating the encoder network, the prior network, and the decoder network by minimizing the loss, and by aligning the reference latent space with the latent space of the prior network. In at least one embodiment, each latent representation from the reference latent space corresponds to a reference trajectory.

According to one or more embodiments of the method, the reference demonstration is provided by a hand-object motion-capture (MoCap) dataset.

According to one or more embodiments of the method, the method is performed by at least one of: a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing remote operations, a system for performing real-time streaming, a system for generating or presenting one or more of augmented reality content, virtual reality content, or mixed reality content, a system implemented using an edge device, a system implemented using a robot, a system for performing conversational AI operations, a system implementing one or more language models, a system implementing one or more large language models (LLMs), a system implementing one or more vision language models (VLMs), a system implementing one or more multi-modal language models, a system for generating synthetic data, a system for generating synthetic data using AI, a system for performing one or more generative AI operations, a system incorporating one or more virtual machines (VMs), a system implemented at least partially in a data center, a system implemented at least partially using cloud computing resources, a system using or deploying one or more inference microservices, or a system that incorporates one or more machine learning models deployed in a service or microservice along with an OS-level virtualization package (e.g., a container).

A machine-readable medium is provided having stored thereon a set of instructions, which if performed by one or more processors, cause the one or more processors to perform the method for obtaining a robot control policy.

A system is provided, which includes one or more processors configured to: train a first policy to generate an action sequence based on a reference demonstration that provides, for one or more time steps, reference states of a human hand and an object, and train, using the first policy, a second policy to generate robot actions based on perception data. In at least one embodiment, training the first policy includes: obtaining the reference demonstration, generating, by the first policy for the one or more time steps, a sequence of actions for controlling a robot end effector to interact with the object, computing, based on the sequence of actions and the reference states, one or more rewards, and updating parameters of the first policy based on the one or more rewards. The rewards are computed based on a mapping between an anatomy of the human hand and an anatomy of the robot end effector and one or more spatial envelopes for one or more anatomical components of the robot end effector.

According to one or more embodiments of the system, training the first policy also includes: receiving initial states of the robot end effector and object corresponding to the reference demonstration, and initializing the robot end effector and the object using the initial states.

According to one or more embodiments of the system, one or more episodes of the plurality of episodes are terminated. In at least one embodiment, each terminated episode is terminated when the one or more rewards satisfy one or more early termination conditions.

According to one or more embodiments of the system, the one or more rewards include a state-reference matching reward and an energy regularization reward. The state-reference matching reward corresponds to kinematic state matching based on distances between the robot end effector and the object and one or more tactile indicators corresponding to contacts between the robot end effector and the object. The energy regularization reward corresponds to smoothness of robotic motions induced by the first policy.

According to one or more embodiments of the system, the second policy is learned by a model including a prior network configured to encode the perception data to sample a latent representation from a latent space and a decoder network configured to decode the sampled latent representation into an action sequence.

According to one or more embodiments of the system, training the second policy includes: encoding, using an encoder, a plurality of reference demonstrations to produce a reference latent space comprising a plurality of latent representations, the reference latent space associated with a reference latent representation distribution, generating, by the first policy, a reference action sequence corresponding to a given reference trajectory, sampling, using the prior network and based on the perception data, a latent representation from a latent space of the prior network, wherein during training, the latent space of the prior network is compensated using the reference latent representation distribution of the reference latent space, decoding, using the decoder network, the sampled latent representation to generate a predicted action sequence, computing a loss between the reference action sequence and the predicted action sequence, and updating the encoder network, the prior network, and the decoder network by minimizing the loss, and by aligning the reference latent space with the latent space of the prior network. In at least one embodiment, each latent representation from the reference latent space corresponds to a reference trajectory.

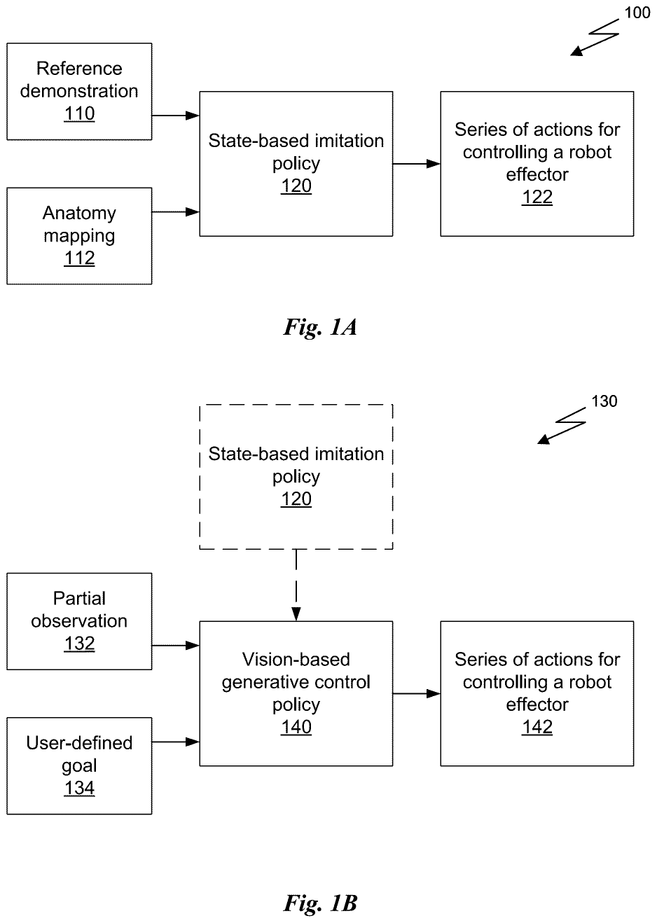

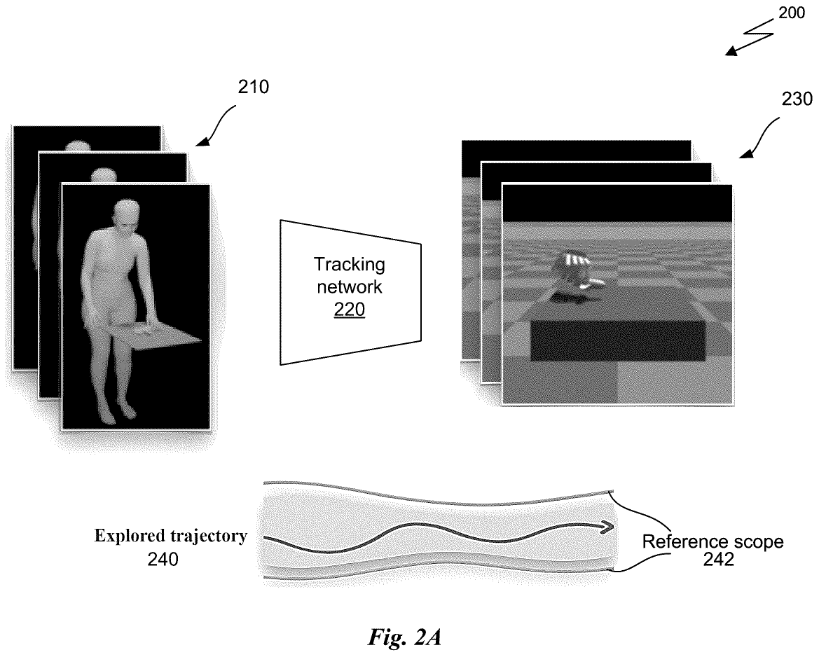

FIG. 1A illustrates a first model 100, according to one or more embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the first model 100 is within the scope and spirit of embodiments of the present disclosure.

The first model 100 implements a first policy, i.e., state-based imitation policy 120. The state-based imitation policy 120 receives a reference demonstration 110 and an anatomy mapping 112 as input, and outputs a series of actions 122 for controlling a robot end effector (such as a robot hand). In at least one embodiment, the reference demonstration 110 illustrates a sequence of human poses performing a specific task, such as grabbing an object. The state-based imitation policy 120 predicts robot actions based on the human poses shown in the reference demonstration. As such, the reference demonstration 110 capture human-object interactions that serve as targets for the state-based imitation policy 120 to imitate. The anatomy mapping 112 defines a correspondence between the anatomy of the referenced human hand and the actual robot end effector. For example, the robot end effector may be a robot hand with multiple joints and digits, and the anatomy mapping 112 specifies which digit or joint of the robot hand corresponds to which finger or joint of the human hand. The state-based imitation policy 120 provides, as output, a time-ordered series of actions for controlling a robot end effector based on the reference demonstration 110 and the anatomy mapping 112 received as input.

In at least one embodiment, a hand-object motion-capture (MoCap) dataset, which includes time-series data of hand interactions with objects, provides a plurality of reference demonstrations used to train state-based imitation policy 120. For example, each reference demonstration may include a sequence of frames showing a human hand manipulating an object. These frames define a series of target states, from which the state-based imitation policy 120 learns to control the robot hand at each timestep (t) to follow a pose trajectory. In at least one embodiment, the MoCap dataset additionally provides the anatomy mapping between the referenced human hand and the robot hand.

In at least one embodiment, a relaxed learning objective is utilized during training of the state-based imitation policy 120, enabling the state-based imitation policy 120 to achieve mimicking the reference demonstration while accommodating anatomical differences between a human hand in the reference demonstration and the robot end effector. The anatomical differences may include the number of digits, the number of joints per digit, the range of motion of each joint, the force capacity of each joint actuator, the size of each digit, etc.

In at least one embodiment, the learning objective is provided by a reward function. The reward function guides the first policy toward recovering or mimicking hand trajectories from a reference demonstration. In certain embodiments, the reward function is constructed using several matching terms, such as a state-reference matching term and an energy regularization term. The state-reference matching term evaluates deviations between the states observed in the reference demonstration and the states provided by the first policy. For example, the first policy may predict robot actions that may be used to derive the states of the robot end effector. In certain embodiments, soft guidance is applied when evaluating the state of the robot end effector (e.g., the humanoid robot hand) in relation to the state of the referenced human hand. For example, rather than requiring strict adherence to the exact geometry of the human hand, the reference points may be defined with margins, thereby forming an “envelope” within which the corresponding robot anatomy may be located without incurring a penalty in the state-reference matching term. The energy regularization term evaluates smoothness of the resulting robot motion, for example, through penalizing significant variations in consecutive proportional-derivative (PD) targets, as well as high joint accelerations and velocities.

The state-reference matching term evaluates the deviations in two aspects. The first aspect relates to the matching between the state observed in the reference demonstration and the state simulated based on the first policy, which is referred to as the kinematic state matching. For example, the kinematic state matching evaluates deviations between the reference state and the simulated state in joint rotations and positions, as well as object orientation and position. The kinematic state matching encourages the robot end effector to follow the natural human-like motions. The second aspect relates to the evaluation of the interaction between the robot end effector and the object, which is referred to as the dynamic state matching. In at least one embodiment, the interaction is evaluated through (i) vectors pointing from each hand joint to the nearest surface points of the object, and (ii) contact indicators that reflect whether each rigid body on the robot end effector is in contact with the object. The dynamic state matching accommodates anatomical differences, for example, by preventing the robot end effector from exactly replicating human demonstration kinematics.

In at least one embodiment, the state-based imitation policy 120 is trained by first initializing the robot's states at the start of an episode and simulating the robot to follow a target trajectory defined by a reference demonstration. Learnable parameters of the state-based imitation policy 120 are then updated based on the rewards accumulated throughout the episode, which evaluate the simulation against the reference trajectory. After training over multiple episodes to learn from various reference trajectories, the trained state-based imitation policy 120 is obtained.

In at least one embodiment, the state initialization only sets the global rotation and translation of the robot palm of a humanoid robot hand according to the referenced hand pose and initialize all other degrees of freedom for the humanoid robot hand to zero. Early termination criteria is implemented to halt episodes when manipulation significantly deviates from feasible or desired trajectories. In at least one embodiment, early termination conditions are disabled initially, allowing sufficient time for the policy to adapt and align with the reference. In at least one embodiment, prioritized sampling is implemented, emphasizing initialization around the critical manipulation stages rather than preliminary approach stages, and prioritizing cases that previously resulted in failed rollouts. This approach ensures more efficient learning by focusing on challenging scenarios.

In at least one embodiment, the state-based imitation policy 120 is trained by a flexible trajectory exploration strategy, which is referred to as reference-scoped exploration (RSE). RSE reduces the reliance on tracking rewards, allowing the policy's behavior to be guided instead by early termination criteria. In certain embodiments, the reward function incorporates a reward weighting scheme based on the reward terms disclosed herein, such as the state-reference matching term and the energy regularization term. For example, the weights for kinematic matching rewards are proportional to the hand-object surface distance, whereas the weight for the energy-based reward is inversely proportional to this distance, for promoting smoother trajectories during periods of relaxed tracking constraints. Furthermore, the scope of trajectory exploration is defined via adaptive early termination criteria, in which the termination criteria is initialized with a large value and adaptively tightened, e.g., based on a ratio of unsuccessful trials to total rollouts.

FIG. 1B illustrates a second model 130, according to one or more embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the second model 130 is within the scope and spirit of embodiments of the present disclosure.

The second model 130 includes a second policy (i.e., vision-based generative control policy 140), which is trained utilizing the knowledge of the first policy. As shown in FIG. 1B, knowledge of the state-based imitation policy 120 (e.g., obtained via knowledge distillation) is used for the training of the vision-based generative control policy 140. The vision-based generative control policy 140, once trained, is suitable for deployment in a robot to enable the robot to interact with its environment. In certain embodiments, the vision-based generative control policy 140 is implemented as a vision-based generative controller. The vision-based generative control policy 140 outputs a series of robot actions 142 for controlling a robot end effector based on partial observations 132 and sparse, user-defined goals 134. During inference, the partial observations 132 are, in certain embodiments, obtained in the form of sensory data, e.g., from one or more cameras and tactile sensors. The user-defined goal may be provided, in certain embodiments, as a desired wrist trajectory, in which case, the second policy would control the robot while attempting to follow the given wrist trajectory. In certain embodiments, the user-defined goal 134 is provided as a natural language instruction, in which case the vision-based generative control policy 140 would control the robot to perform the natural language instruction.

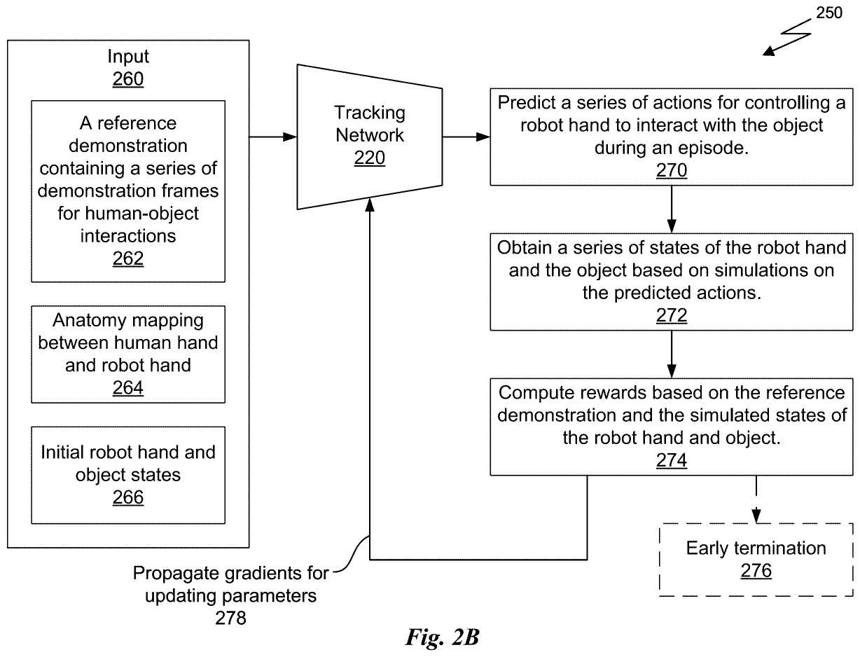

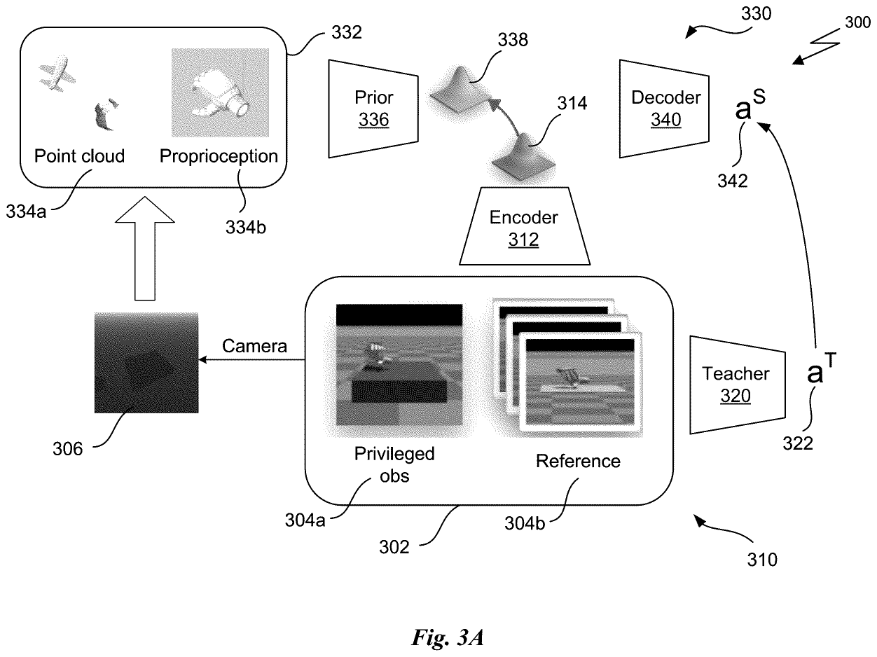

FIG. 2A illustrates an example architecture 200 for training a state-based imitation policy, according to one or more embodiments of the present disclosure. As shown in FIG. 2A, a neural network 220, denoted as the “tracking” network, is trained to learn the first policy using a reference demonstration 210 (including a sequence of frames) within a simulation environment, such as the simulation 230. Simulation refers to a virtual environment in which the robot's physics, kinematics, contacts, and/or dynamics are modeled. The tracking network 220 may be constructed using various types of neural networks, including a multilayer perceptron (MLP).

Hereinafter, an example mathematical model is described for the purpose of establishing and facilitating the training of one or more neural networks. While the example illustrates one particular implementation, it should be understood by those skilled in the art that the demonstrated principles may be applied to other suitable network architectures.

The training of the tracking network 220 is formulated as a task aimed at deriving a policy (π) capable of controlling a humanoid robot hand (or a robot hand for short) to manipulate objects according to provided reference motions. The simulated robot-object interactions are provided by the simulation 230, which are represented as pose trajectories,

$${\{ {x}_{t} \}}_{t = 1}^{T} ,$$

over time intervals t=1 to T. The policy (π) targets retargeting and imitating reference demonstration derived from human hand motions.

In at least one embodiment, the training dataset is obtained from the MoCap dataset, which provides abundant, contact-rich human demonstrations for scaling dexterous manipulation on robots. For example, the training dataset may include sequences of demonstration frames showing a hand interacting with an object in a scene, such as approaching, grasping, manipulating, and releasing the object. In at least one embodiment, the training dataset includes three-dimensional (3D) hand pose datasets built upon a predefined parametric hand model, such as the MANO model. The MANO model is a parametric hand mesh model trained from scans of real human hands and represents the hand in a low-dimensional pose and shape space.

In at least one embodiment, the hand in the demonstration is represented by an articulated hand model including a series of connected joints, with each joint having a parent joint in the kinematic hierarchy. A joint defined relative to its parent may have its position or rotation specified in the coordinate frame of the parent joint, rather than in absolute world coordinates. In certain embodiments, the hand pose may include a floating root joint at the wrist, given in world coordinates, with all other joints expressed relative to their parent joints.

In at least one embodiment, the poses of the object are defined by six degrees of freedom (6-DoF) in world coordinates, for example, including three translational DoF (X, Y, Z positions) and three rotational DoF (roll, pitch, yaw) in 3D space. In certain embodiments, the training dataset includes interactions between the hand and rigid objects, which are used to train the tracking network 220 to learn object manipulation behaviors.

In at least one embodiment, the policy learning, such as the reference imitation process, is framed as a reinforcement learning problem structured around a Markov Decision Process (MDP), where the agent (e.g., the policy π) learns to reproduce the demonstrated behaviors through interaction with the environment. In the MDP framework, the learning problem is defined by a set of predefined parameters, including states, robot actions, transitions, and a designed reward structure. The states describe the environment at specific times, for example including the pose and/or motion of the robot hand and/or the object. The robot actions correspond to movements (e.g., commands or control signals) applied to each joint of the robot hand. The transitions define how the environment (e.g., the robot hand and/or the object) changes in response to the agent's actions, such as the transition from one state to the next upon taking an action. The reward structure may include a reward function that provides an intermediate reward (e.g., positive or negative) to the agent after executing an action in a given state, and optionally a discount factor (between 0 and 1) that determines the relative value of future rewards compared to immediate rewards.

At every timestep t, the policy π acts on a hand proprioception and an observation component (xₜ), combined with a goal-oriented reference component (\hat{x}ₜ). In at least one embodiment, the hand proprioception may be represented by one or more sensory modalities. The observation component (xₜ) may include states of the robot hand and the object. The hand proprioception and the observation component (xₜ) may collectedly be referred to as the state of the robot environment. The goal-oriented reference component (\hat{x}ₜ) may include states of the hand in the reference demonstration.

In at least one embodiment, the state of the robot environment includes hand kinematics (e.g., of the robot hand), object positioning, and sensory modalities, formulated as:

$${x}_{t} = \{ \{ {R}_{t}^{h} , {J}_{t}^{h} , {ω}_{t}^{h} , {v}_{t}^{h} \} , \{ {R}_{t}^{o} , {p}_{t}^{o} , {ω}_{t}^{o} , {v}_{t}^{o} \} , \{ {D}_{t} , {C}_{t} \} \} \qquad ( Eq . 1 )$$

where

$${R}_{t}^{h} , {J}_{t}^{h}$$

represent the joint rotations and positions of the robot's hand, respectively;

$${ω}_{t}^{h} , {v}_{t}^{h}$$

denote the angular and linear velocities of the hand joints, respectively;

$${R}_{t}^{o} , {p}_{t}^{o}$$

represent the object's orientation and position, respectively;

$${ω}_{t}^{o} , {v}_{t}^{o}$$

denote the angular and linear velocities of the object, respectively; Dₜ, Cₜ represent sensory modalities. In at least one embodiment, coarse geometry and tactile cues are integrated through the sensory modalities (Dₜ, Cₜ). In certain embodiments, the sensory modality Dₜ consists of vectors pointing from each hand joint to the nearest surface points of the object, while the sensory modality Cₜ includes binary contact indicators that reflect whether each rigid body on hand is in contact, for example to mimic the tactile sensing. During the training phase, the object positioning may be privileged object positioning, which refers to positioning data that is available during training but not during inference, for example, the exact position of the object in 3D space. Similarly, the reference state of the environment can be formulated as:

$${\hat{x}}_{t} = \{ \{ {\hat{R}}_{t}^{h} , {\hat{J}}_{t}^{h} , {\hat{ω}}_{t}^{h} , {\hat{v}}_{t}^{h} \} , \{ {\hat{R}}_{t}^{o} , {\hat{p}}_{t}^{o} , {\hat{ω}}_{t}^{o} , {\hat{v}}_{t}^{o} \} , \{ {\hat{D}}_{t} , {\hat{C}}_{t} \} \} \qquad ( Eq . 2 )$$

which defines the hand kinematics of the human hand, object positioning, and similar sensory modalities derived from the reference demonstration (e.g., provided in the training dataset).

Furthermore, a goal reference state (\hat{x}ₜ) at each timestep is derived from the reference demonstration structured as: {\hat{x}ₜ₊ₖ}_{k∈K}. Each future state (\hat{x}ₜ₊ₖ) is defined as:

$$\{ \{ M ( {\hat{R}}_{t + k}^{h} ) ⊖ M ( {R}_{t}^{h} ) , M ( {\hat{J}}_{t + k}^{h} ) - M ( {J}_{t}^{h} ) \} , \{ {\hat{R}}_{t + k}^{o} ⊖ {R}_{t}^{o} , {\hat{p}}_{t + k}^{o} - {p}_{t}^{o} , \} , \{ M ( {\hat{D}}_{t} ) ⊖ M ( {D}_{t} ) , M ( {\hat{C}}_{t + k} ) ⊖ M ( {C}_{t} ) \} , \{ {\hat{R}}_{t + k}^{h} , {\hat{J}}_{t + k}^{h} , {\hat{R}}_{t + k}^{o} , {\hat{p}}_{t + k}^{o} \} \} \qquad ( Eq . 3 )$$

where Θ denotes the operation that computes the rotation difference between two orientations. In certain embodiments, the robot hand and the demonstration state (\hat{⋅}) employ different skeletal structures, as the robot hand can have a different number of digits and joints compared to the human hand (or another suitable reference manipulator). M represents a mapping operation to project both skeletal structures onto a shared subset of key joints before computing the deltas (or differences) in Equation 3. In certain embodiments, all continuous components are expressed in a coordinate frame anchored at the hand's floating root joint and canonicalized (or normalized) relative to the rotation of that root joint.

During training, the policy (π) generates robot actions, receives states (e.g., the states of the robot environment) and rewards from the environment, and updates its parameters to maximize the expected reward according to the designed reward structure. In the example illustrated in FIG. 2A, the simulation 230 serves as the environment where the policy (π) interacts, collects experience, and learns efficiently before deployment on a real robot. The simulation 230 may employ the low-level controller to convert high-level proportional-derivative (PD) targets or actions into joint torques that produce the corresponding motions in the simulated robot hand. As such, the simulation 230 executes and tests the robot hand's motions in a controlled virtual environment.

The robot actions control the robot hand to move from one state to the next state. In at least one embodiment, the robot control includes two components: (i) a 6-DoF floating-wrist signal, denoted as

$${a}_{t}^{g} ∈ {ℝ}^{6} ,$$

and (ii) a set of local finger commands, denoted as

$${a}_{t}^{l} ,$$

where a denotes the action. In at least one embodiment, each element of

$${a}_{t}^{g} and {a}_{t}^{l}$$

corresponds to a PD target, with rotations expressed using an exponential-map parametrization.

In at least one embodiment, during simulation, the targets (e.g., the PD targets) are converted to joint torques by the low-level controller. To obtain the PD targets for kinematically coupled (mimic) joints, the controller scales the driving joint's target by a predefined coefficient that mirrors the mechanical coupling in the real hand. In certain embodiments, the policy operates in a residual action space for

$${a}_{t}^{g} ,$$

where the residual is added to the current state to form the PD target for global motion, thereby ensuring that the network does not need to learn or generalize from unbounded global trajectories.

At each timestep (t), a reward is computed from two complementary components: a state-reference matching term, denoted as R_{match}(xₜ, xₜ), and an energy regularization term, denoted as R_{energy}(aₜ), where R represents the reward. The state-reference matching term, R_{match}(xₜ,\hat{x}ₜ), encourages the simulated state (xₜ) to align closely with the demonstration (or reference) state (\hat{x}ₜ). In at least one embodiment, the state-reference matching further incorporates (i) kinematic state matching, for joint rotations and positions

$$( {R}_{R}^{h} , {R}_{J}^{h} )$$

and object orientation and position

$$( {R}_{R}^{o} , {R}_{p}^{o} ) ;$$

anu (ii) correspondences for coarse geometric (R_{D}) and tactile (R_{C}). The energy regularization term, R_{energy}(aₜ), is added to penalize significant variations in consecutive PD control targets, as well as high joint accelerations and velocities. This energy term can be used to prevent excessive actuation and promote smoother, energy-efficient motions.

The robot and human hands may differ in shape, kinematic structure, and degrees of freedom, rendering a naive one-to-one mapping of joint locations or angles impractical. The present disclosure formulates the rewards to support retargeting purposes to accommodate embodiment gaps.

In at least one embodiment, the kinematic state matching is designed to ensure that the robot matches fingertip positions while also aligning the global orientations of key rigid bodies such as the palm to produce natural, human-like motions. Formally, the set of the fingertips is denoted as [symbol] and the set of key rigid bodies is denoted as B. As such, the reward associated with the fingertip positions is defined as:

$${R}_{J}^{h} = exp ( - {\sum }_{f ∈ ℱ} {λ}_{J}^{h} {‖ {\hat{p}}_{f} - {p}_{f} ‖}^{2} ) , \qquad ( Eq . 4 a )$$

where p_{f} is the fingertip position of the robot hand, \hat{p}_{f} is the fingertip position of the reference hand, and

$${λ}_{J}^{h}$$

is a hyperparameter. The reward associated with the body rotations is defined as:

$${R}_{R}^{h} = exp ( - {\sum }_{b ∈ ℬ} {λ}_{R}^{h} {‖ {\hat{R}}_{b} ⊖ {R}_{b} ‖}^{2} ) , \qquad ( Eq . 4 b )$$

where

$${λ}_{R}^{h}$$

is a hyperparameter. As shown in Equations 4a and 4b, a larger difference between the corresponding fingertip positions results in a smaller reward, and a larger rotation difference between the corresponding bodies also leads to a smaller reward. In certain embodiments, soft guidance is applied when evaluating the state of the robot hand in relation to the state of the referenced hand (e.g., the referenced human hand). For example, the reference points, such as the fingertips and/or the rigid bodies, may be defined with margins, thereby forming an “envelope” within which the corresponding robot anatomy may be located without incurring a penalty (or reducing the reward) in the state-reference matching term.

In at least one embodiment, the dynamic state matching is designed to promote the fingertips to remain close to relevant affordances and to maintain correct fingertip contact correspondences. Formally, the dynamic state matching utilizes alignment rewards, expressed as:

R_{D}=exp(−λ_{D}∥\hat{D}−D∥²), (Eq. 5a)

R_{C}=exp(−λ_{C}BCE(\hat{C}−C)), (Eq. 5b)

where BCE (⋅;⋅) denotes the binary cross-entropy loss applied to discretized force sensing signals (C), λ_{D} and λ_{C} are hyperparameters. As shown in Equations 5a and 5b, the alignment between the corresponding sensory modalities (D and C) may provide additional award to the agent (e.g., the policy). As such, the dynamic rewards encourage manipulation dynamics even when embodiment differences prevent the robot from exactly replicating human demonstration kinematics.

In at least one embodiment, early termination criteria is employed to halt episodes when manipulation significantly deviates from feasible or desired trajectories. The termination conditions may be defined as:

$$( i ) {R}_{J}^{h} < {τ}_{J}^{h} , ( ii ) {R}_{p}^{o} < {τ}_{p}^{o} , ( iii ) {R}_{R}^{o} < {τ}_{R}^{o} , ( iv ) {R}_{D} < {τ}_{D} , ( v ) {C}_{t} \neq {\hat{C}}_{t} ,$$

where

$$∀ t ∈ [ {t}_{0} , {t}_{0} + 10 ] , {τ}_{J}^{h} , {τ}_{p}^{o} , {τ}_{R}^{o} ,$$

and τ_{D} are preset termination thresholds. In this configuration, the conditions are monitored continuously over a time window of ten time steps (or ten units of simulation time). These criteria promptly terminate episodes when interactions deviate irrecoverably from the reference trajectories, for example, when the robot hand loses stable contact with the object, moves outside of the predefined workspace, or fails to maintain consistent fingertip correspondences.

In at least one embodiment, at the beginning of the training, the state of the robot hand is initialized such that the global rotation and translation of the robot palm are set according to the reference hand pose (e.g., the MANO pose), while all other DoFs of the robot hand are initialized to zero. From the initialized state, the robot hand is trained in each episode until a termination condition is satisfied. In certain embodiments, early termination conditions are disabled initially, allowing sufficient time for the policy to adapt and align with the reference.

In at least one embodiment, prioritized sampling is implemented, for example, to tailor the training dataset toward more relevant data. For example, the sampling may emphasize initialization around critical manipulation stages rather than preliminary approach stages, and/or prioritize cases that previously resulted in failed rollouts. This approach ensures more efficient learning by focusing on challenging scenarios.

The training disclosed herein is performed using learning with reference scope, which utilizes the reference scope 242 to guide the robot hand to follow the trajectory 240 constrained within the reference scope. This approach enables a flexible trajectory exploration within a unified limitation learning framework that integrates retargeting, tracking, and correction. Specifically, learning with reference scope is designed to diminish the reliance on tracking rewards, permitting the policy's behavior to be shaped by early termination criteria. In certain embodiments, learning with reference scope is implemented with the following designs. First, a reward weighting scheme is introduced: the weights for the kinematic matching rewards, such as

$${λ}_{R}^{h} and {λ}_{J}^{h} ,$$

are proportional to the hand-object surface distance, whereas the weight for the energy-based reward (R_{energy}(aₜ)) is inversely proportional to this distance. This approach promotes smoother trajectories during periods of relaxed tracking constraints. Second, the scope of trajectory exploration is defined by adaptive early termination criteria. Each termination threshold (τ) is initialized with a large value and adaptively tighten based on the ratio of unsuccessful trials to total rollouts. For example, an adaptive termination threshold is updated as:

$$τ = {τ}^{init} \frac{{N}_{fail}}{{N}_{total}} , \qquad ( Eq . 6 )$$

where τ^{init} is an initial large threshold, N_{fail} is the number of attempts at the current frame, and Nₜₒₜₐₗ is the number of total rollouts at the current frame. In certain embodiments, the termination threshold (τ) is defined independently for each frame and subsequently smoothed across neighboring frames to maintain temporal coherence.

In at least one embodiment, the Proximal Policy Optimization (PPO) algorithm is leveraged to learn the policy. PPO is a reinforcement learning algorithm that optimizes the policy by balancing exploration and exploitation while maintaining stable and efficient training. Specifically, PPO constrains policy updates to stay within a trust region by clipping large policy changes, thereby preventing performance collapse and ensuring smooth convergence during learning.

FIG. 2B illustrates an example process 250 for training the first policy (e.g., the state-based imitation policy 120), according to one or more embodiments of the present disclosure. Each block of the process, described herein, comprises a computing process that may be performed using any combination of hardware, firmware, and/or software. For instance, various functions may be carried out by a processor executing instructions stored in memory. The process may also be embodied as computer-usable instructions stored on computer storage media. The process may be provided by a standalone application, a service or hosted service (standalone or in combination with another hosted service), or a plug-in to another product, to name a few. This process may be executed by any one system, or any combination of systems, including, but not limited to, those described herein. Furthermore, persons of ordinary skill in the art will understand that any system that performs functions of the process 250 is within the scope and spirit of embodiments of the present disclosure.

The framework 250, as shown in FIG. 2B, may be employed to perform the process 200 shown in FIG. 2A to train the tracking network 220.

The input 260 to the tracking network 220 includes a reference demonstration 262 containing a series of demonstration frames for human-object interactions, an anatomy mapping 264 between the human hand and the robot hand, and initial states 266 of the robot hand and object. Certain input data, such as the reference demonstration 262, may be derived from the reference demonstrations 210. Other input data, such as the anatomy mapping 264 between the human hand and the robot hand, may be user-defined. The initial states 266 of the robot hand and object may be determined based on hybrid data, for example, by considering both the reference demonstrations 210 and user-defined parameters. However, other suitable ways of obtaining the input data may also be employed depending on the particular implementation.

In certain embodiments, the tracking network 220 receives the reference demonstration 262 corresponding to a full trajectory, which the tracking network 220 uses to learn over multiple episodes. The initial states 266 of the robot hand and object are used to initialize the training at the start of each episode.

For each episode, the tracking network 220 performs stages 270 through 278. At stage 270, the tracking network 220 predicts a series of actions for controlling the robot hand to interact with the object during the episode. At stage 272, the tracking network 220 obtains a series of states of the robot hand and the object based on simulations on the predicted actions. For example, the simulation 230 is used to simulate the interactions between the robot hand and the object by applying the series of actions predicted by the tracking network 220. At stage 272, the tracking network 220 computes rewards based on the reference demonstrations and the simulated states of the robot hand and object. For example, as discussed with reference to FIG. 2A, the simulated states corresponding to Equation 1 and the referenced states corresponding to Equation 2 may be obtained and evaluated to compute the rewards, such as those given by Equations 3 and 4. When early termination is enabled, the training of the current episode may be halted at stage 276 based on the earlier termination criteria disclosed herein. After completion of a full episode, in which the training of the entire trajectory is performed, the computed rewards may be used to obtain gradients. At stage 278, the gradients may then be propagated to update the learnable parameters of the tracking network 220.

In certain embodiments, after the tracking network 220 has been trained on a reference demonstration 262, the tracking network 220 may receive another reference demonstration 262 containing a series of demonstration frames to learn from another reference trajectory. In this way, the tracking network 220 can learn multiple different trajectories and capture varying interactions between the referenced hand (which may be of different types) and various objects.

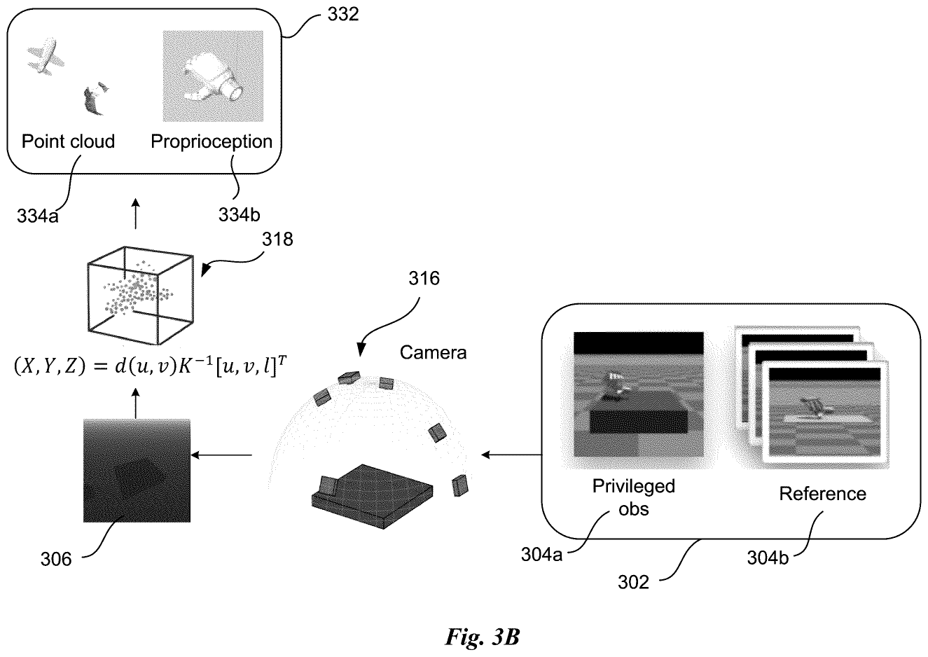

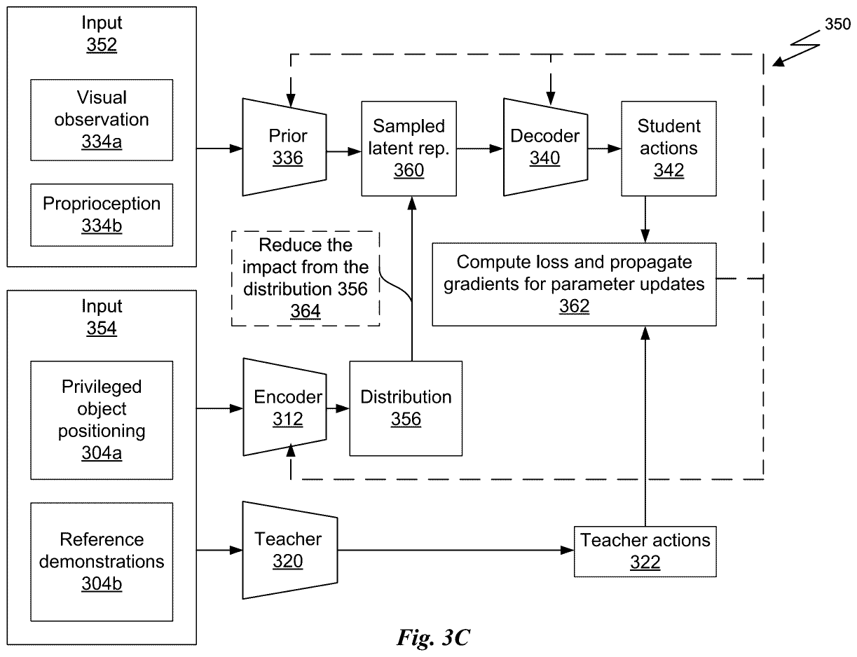

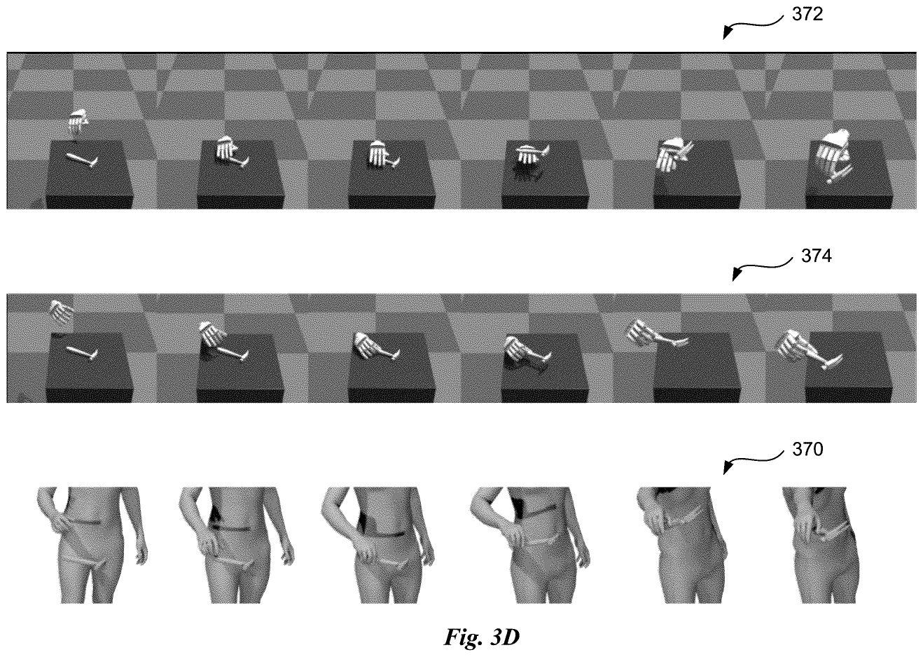

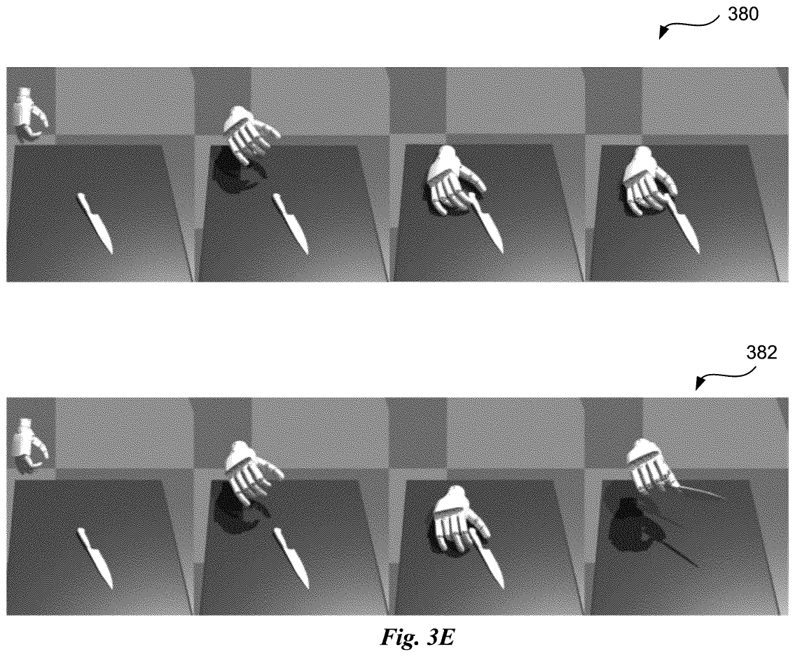

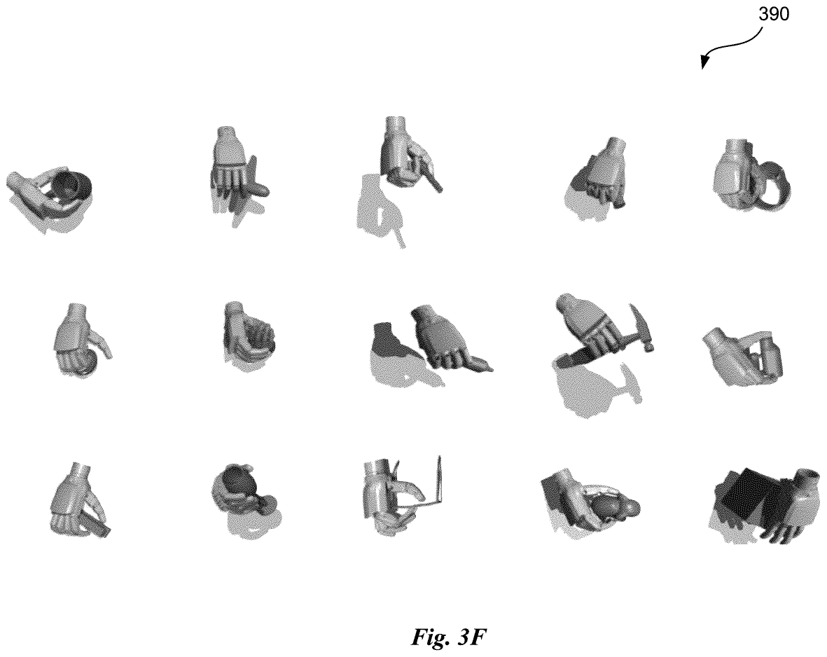

FIG. 3A illustrates an example architecture 300 for training a vision-based generative control policy, according to one or more embodiments of the present disclosure. The architecture 300 is designed to leverage knowledge distilled from the first policy to train the second policy. For example, the first policy is learned by the teacher network 320 (also referred to as the teacher 320), which may be the tracking network 220 trained through the process 200 as shown in FIG. 2A and/or the framework 250 shown in FIG. 2B. As shown in FIG. 2B, two branches are implemented during training, including a student branch 330, which trains a student network to learn the second policy, and a teacher (or expert) branch 310 that distills knowledge from the first policy to provide guidance for the student branch 330. The second policy is denoted as \tilde{π}.

The teacher branch 310 includes the teacher network 320 and an encoder network 312 (also referred to as the encoder 312) that is configured to encode the observation data 302 into a latent representation within a latent space 314. The observation data 302 includes privileged object positioning 304a and one or more reference demonstrations 304b. The privileged object positioning 304a refers to positioning data that is available during training but not during inference, for example, the exact position of the object in 3D space. The one or more reference demonstrations 304b may provide reference trajectories represented by human demonstrations (or other suitable demonstrations). The encoder 312 is configured to encode the reference trajectories into corresponding latent representations (e.g., latent embeddings). Each latent representation corresponds to a specific reference trajectory. The latent representations generated by the encoder 312 collectively form a Gaussian distribution within the latent space 314. The teacher 320 provides an action prediction (a^{T}) 322 corresponding to the first policy. In certain embodiments, the actions correspond to actuator commands, such as torque commands and/or joint position commands. However, other suitable types of signals, instructions, or commands may also be employed.

The student branch 330 includes a prior network 336 (also referred to as the prior 336) and a decoder network 340 (also referred to as the decoder 340). The prior 336 is configured to sample a latent representation from its associated latent space 338 conditioned on the perception data 332 from the environment. As indicated by the arrow, the training results in the latent space 314 being aligned toward the latent space 338. To mimic the perception of a robot, the perception data may include partial observations from the environment. In at least one embodiment, the perception data 332 from the environment includes visual observation 334a of the environment from a single-view perspective. The visual observation 334a of the environment may be represented by a partial point cloud (P). For example, the partial point cloud (P) may be obtained from a single-view depth image 306, derived from the observation data 302 including the privileged object positioning 304a and/or the one or more reference demonstrations 304b.

FIG. 3B illustrates an example process for generating a point cloud-based representation 334a based on the privileged object positioning 304a, according to one or more embodiments of the present disclosure. As indicated by arrow 316, the depth image 306 is captured by a camera positioned at locations sampled around a hemisphere above the table, using preset intrinsic parameters.

A point cloud 318 can be generated from the depth image 306 by back-projecting each pixel into three-dimensional (3D) space using the camera's intrinsic parameters (K). Specifically, for a pixel at image coordinates (u, v) with a corresponding depth value d(u, v), the 3D coordinates (X, Y, Z) in the camera coordinate system can be obtained as (X, Y, Z)=d(u, v)K⁻¹[u, v, l]^{T}, where K⁻¹ represents the inverse of the camera intrinsic matrix, u, v are the 2D pixel coordinates in the image plane, and l is a homogeneous coordinate that may take a value of one. This transformation maps each pixel from the image plane into its corresponding position in 3D space, forming the basis of the point cloud representation. The point cloud-based representation 334a can be rendered from the pixels obtained from the point cloud 318.

In at least one embodiment, the perception data 332 also includes a predefined goal, such as proprioception 334b, which may be used to indicate how the robot hand is positioned and moving. For example, hand proprioception (\tilde{x}) may be used, which includes the global wrist position and rotation, as well as local joint rotations, serving as a desired wrist trajectory (denoted as T_{g}). Alternatively and/or additionally, a user-defined goal may be provided, for example, as a task description and/or natural language instruction, in which case the second policy would control the robot to perform the natural language instruction.

However, it should be understood that other suitable types of perception data, visual observations, and/or predefined goals may also be used.

Referring back to FIG. 3A, the decoder 340 is configured to decode a sampled latent representation to generate an action prediction (a^{S}) 342 corresponding to the second policy. In at least one embodiment, the input to the decoder 340 includes the proprioception 334b and the sampled latent representation.

As such, training of the second policy is formulated as a generative control task that derives the policy (\tilde{π}), such as the decoder policy (\tilde{π}), to enable a robotic hand to manipulate an object using only partial observations and a user-defined goal. The latent embedding for generative control is introduced to capture and control diverse behaviors, eliminate dependence on full reference trajectories, and model uncertainty arising from the absence of privileged information during inference.

In at least one embodiment, the encoder 312 is denoted as q_{φ}(z|x, \hat{x}), the prior 336 is denoted as q_{ψ}(z|\tilde{x}, T_{g}), and the decoder policy (learned by the decoder 340) is denoted as: \tilde{π}_{θ}(a|z, \tilde{x}, T_{g}).

The encoder 312 takes full trajectory information, including complete robot-object states (x) and reference states (\hat{x}), to produce an encoder Gaussian latent distribution, denoted as: [symbol] (μ_{q}, Σ_{q}), which is associated with the latent space 314. Concurrently, the prior 336 generates a prior state-dependent Gaussian latent distribution [symbol] (μₚ, Σₚ) conditioned on the perception data 332, where the prior Gaussian latent distribution is associated with the latent space 338. The latent skill embedding (e.g., the latent representation as input to the decoder 340 during training), z~ [symbol] (μₚ+μ_{q},Σ_{q}), is computed at each timestep as:

$$𝓏 = {μ}_{p} + {μ}_{q} + {Σ}_{q}^{1 / 2} ϵ , ϵ ∼ 𝒩 ( 0 , 1 ) , \qquad ( Eq . 7 )$$

where ϵ represents noise. In certain embodiments, the noise (ϵ) remains fixed throughout an episode, ensuring that a consistent skill is performed across timesteps within the same episode. As shown in Equation 7, during training, the sampling is performed to a distribution that combines the prior Gaussian latent distribution and the encoder Gaussian latent distribution. For example, the encoder Gaussian latent distribution is added to the prior Gaussian latent distribution as a residual correction. During inference, the sampling is performed solely on the prior Gaussian latent distribution.

In at least one embodiment, the decoder policy (\tilde{π}) is trained using an online imitation learning procedure based on DAgger, in which the policy is iteratively updated by aggregating data from its own rollouts with corrective actions provided by a reference policy (e.g., a teacher). The previously trained imitation control policy, learned by the tracking network 220, serves as the teacher 320. The training objective is to minimize an action reconstruction loss, formulated as:

L_{rec}=∥a−ã∥², (Eq. 8a)

where ã denotes the predicted actions (e.g., a^{S}), and a represents teacher-provided reference actions (e.g., a^{T}).

In at least one embodiment, a Kullback-Leibler (KL) divergence regularization is used to encourage the encoder distribution to remain close to the prior distribution. The KL divergence regularization can be formulated as:

L_{KL}=D_{KL}(N(μₚ+μ_{q},Σ_{q})∥N(μ_{q},Σ_{q}), (Eq. 8b)

This regularization guides μ_{q} towards zero, constraining the encoder 262 from capturing information irrelevant to full state that is not available at runtime. The total training objective combines these terms as follows:

L=L_{rec}+βL_{KL}, (Eq. 8c)

where β is gradually increased during training to encourage a more structured latent space.

As such, the encoder 312 parameterizes the observed knowledge into latent embeddings, forming an observation knowledge space associated with a Gaussian latent distribution, while the prior 336 captures a latent distribution conditioned on the partial information available to the agent (e.g., the prior 336). During training, the Gaussian distribution produced by the encoder 312 is aligned with the distribution provided by the prior 336, enabling the learned prior 336 to provide contextually relevant information conditioned on the available partial observations and goals. Unlike conventional variational autoencoders (VAEs) that use a fixed prior, the learned prior guides the latent representations to be consistent with information that is accessible during inference. During training, the learnable parameters of the encoder 312, prior 336, and decoder 340 are updated. The training allows the robot hand to follow a given trajectory while being capable of performing diverse object manipulation skills.

At inference time, the encoder 312 is omitted, and the latent embedding is sampled directly from the learned prior 336 with the latent skill embedding: z~N(μₚ,Σ_{q}). This produces a generative control policy (\tilde{π}) capable of performing effective goal-conditioned dexterous manipulation from partial observations alone.

The state-based policy, such as the first policy learned in the first stage, is evaluated for its ability to imitate human demonstrations and generalize to unseen scenarios. The vision-based policy framework, for example to learn the second policy in the second stage, is further assessed for its effectiveness in achieving manipulation within simulation and its successful transfer to real-world deployment. Experiments demonstrate that the policies learned in the present disclosure outperform baseline methods and that the distilled visual policies robustly generalize to unseen objects and exhibit diverse manipulation styles.

FIG. 3C illustrates an example process 350 for training a vision-based generative control policy, according to one or more embodiments of the present disclosure. Each block of the process, described herein, comprises a computing process that may be performed using any combination of hardware, firmware, and/or software. For instance, various functions may be carried out by a processor executing instructions stored in memory. The process may also be embodied as computer-usable instructions stored on computer storage media. The process may be provided by a standalone application, a service or hosted service (standalone or in combination with another hosted service), or a plug-in to another product, to name a few. This process may be executed by any one system, or any combination of systems, including, but not limited to, those described herein. Furthermore, persons of ordinary skill in the art will understand that any system that performs the process 350 is within the scope and spirit of embodiments of the present disclosure.

The framework 350 may be employed to facilitate the training of the second policy using the architecture 300 shown in FIG. 3A.

As discussed with reference to FIG. 3A, the input 352 to the prior 336 includes visual observation 334a and proprioception 334b as the perception data 332. The prior 336 generates a sampled latent representation 360 from the latent space 338. As given by Equation 7, the distribution of the latent space 338 is compensated by a distribution 356 associated with the latent space 314 of the encoder 312. Concurrently, input 354 to the encoder 312 includes privileged object positioning 304a and reference demonstrations 304b as the observation data 302. The encoder 312 generates the distribution 356 based on the input 354. As indicated by the dashed box 364, one training objective is to reduce the impact of the distribution 364 by aligning the distribution of the latent space 338 with the distribution 356 of latent space 314.

Additionally, the sampled latent representation 360 is decoded by the decoder 340 to generate the student actions 342, while the teacher 320 predicts the teacher actions 322 based on the input 354. At block 362, a loss is computed from the difference between the student actions 342 and the teacher actions 322. Gradients may be computed based on the loss and propagated, as indicated by the dashed arrows, to update the learnable parameters in the networks, such as the prior 336, the decoder 340, and/or the encoder 312.

The training may be performed over multiple episodes for a reference demonstration from the reference demonstrations 304b, and further repeated for different reference demonstrations.

FIGS. 3D and 3E show example simulation results compared with other models, according to one or more embodiments of the present disclosure.

In FIG. 3D, row 370 illustrates original motion capture (MoCap) data serving as example reference demonstrations used to obtain the second policy disclosed herein. Row 372 depicts retargeting results generated by another model, such as AnyTeleop. Row 374 shows simulation outcomes produced by an embodiment of the second policy of the present disclosure. As can be observed, for hands with limited DoF, the retargeting performed by the AnyTeleop model is insufficient, often resulting in unnatural hand poses and unstable object contacts. In contrast, the tracking results obtained by the embodiment of the second policy of the present disclosure exhibit high-quality imitation that closely follows the reference demonstrations.

In FIG. 3E, row 380 illustrates results obtained from a baseline model, such as DexTrack, performing a task of picking up a knife. Row 382 demonstrates results produced by an embodiment of the second policy of the present disclosure. The comparison indicates that, for objects with small grasping regions, the baseline model fails to achieve a stable grasp, whereas the embodiment of the second policy disclosed herein successfully performs the grasping task.

FIG. 3F illustrates additional simulation results 390, according to one or more embodiments of the present disclosure. The simulation results 390 demonstrate the generalization performance of a policy trained in accordance with an embodiment disclosed herein across various objects, indicating that the trained policy is capable of successfully adapting its actions to previously unseen shapes, sizes, and configurations. These results highlight the robustness and flexibility of the learning approach, showing that the policy can effectively handle a diverse set of scenarios beyond the specific training instances.

Systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

In some examples, the model(s) (e.g., machine learning models, deep neural networks, language models, LLMs, VLMs, multi-modal language models, perception models, tracking models, fusion models, transformer models, diffusion models, encoder-only models, decoder-only models, encoder-decoder models, neural radiance field (NERF) models, etc.) described herein may be packaged as a microservice-such an inference microservice (e.g., NVIDIA NIMs)—which may include a container (e.g., an operating system (OS)—level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs, e.g., REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Systems and methods described herein can be utilized or performed within a simulation environment (e.g., NVIDIA's DriveSIM, ISAAC GYM, and/or ISAAC SIM) using simulated data (e.g., simulated sensor data of simulated sensors of a virtual or simulated machine). For example, simulated sensor data and/or map data (simulated or real) may be used to perform various operations within the simulation environment, such as to generate the simulation data and/or operate a machine. These simulated operations may be used to test performance of underlying algorithms, systems, image processing pipelines, and/or processes prior to deploying them in the real-world. In some instances, the simulation may be used to generate synthetic training data (e.g., training data including landmarks, features, objects, etc.), so that the synthetic training data (in addition to or alternatively from real-world data) may then be processed to perform one or more of the operations described herein.

In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems-such as systems for testing, validating, training (e.g., machine learning models, neural networks, etc.), and/or other tasks related to automotive, robot, machine, or other applications.

More illustrative information will now be set forth regarding various optional architectures and features with which one or more embodiments may be implemented, per the desires of the user. It should be strongly noted that the following information is set forth for illustrative purposes and should not be construed as limiting in any manner. Any of the following architectures and features may be optionally incorporated with or without the other architectures and features described.

### Parallel Processing Architecture

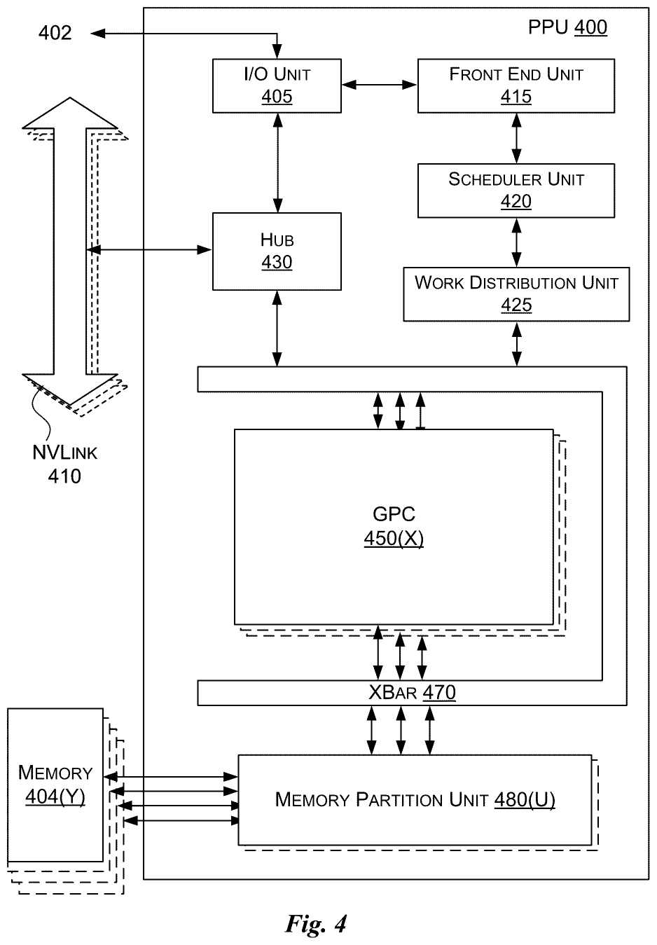

FIG. 4 illustrates a parallel processing unit (“PPU”) 400, according to at least one embodiment. The PPU 400 may be used as a component of one or more embodiments of one or more systems disclosed herein or may be used to implement one or more embodiments of one or more methods disclosed herein. In an embodiment, a processor such as the PPU 400 may be configured to implement a neural network model. The neural network model may be implemented as software instructions executed by the processor or, in other embodiments, the processor can include a matrix of hardware elements configured to process a set of inputs (e.g., electrical signals representing values) to generate a set of outputs, which can represent activations of the neural network model. In yet other embodiments, the neural network model can be implemented as a combination of software instructions and processing performed by a matrix of hardware elements. Implementing the neural network model can include determining a set of parameters for the neural network model through, e.g., supervised or unsupervised training of the neural network model as well as, or in the alternative, performing inference using the set of parameters to process novel sets of inputs.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one example parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

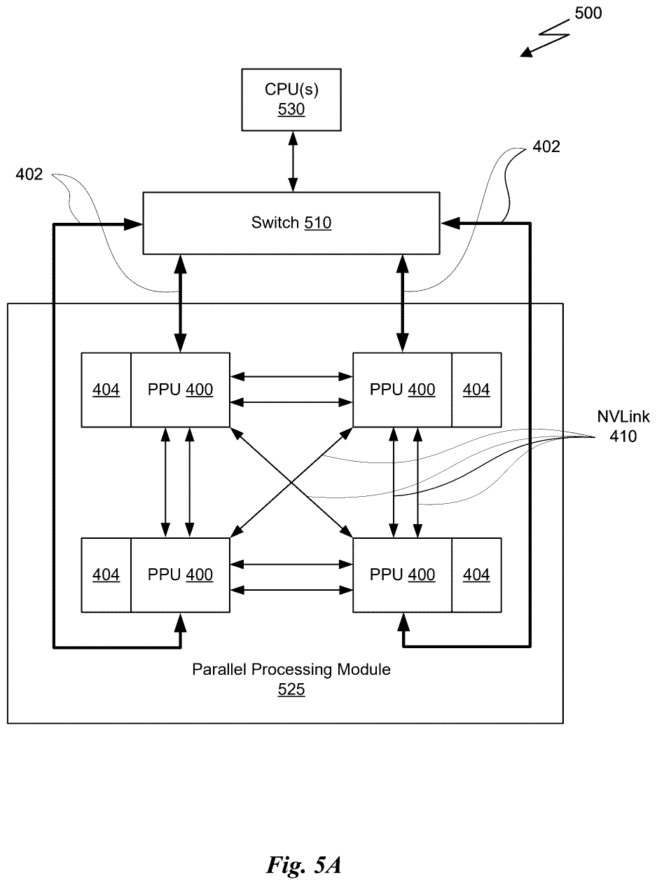

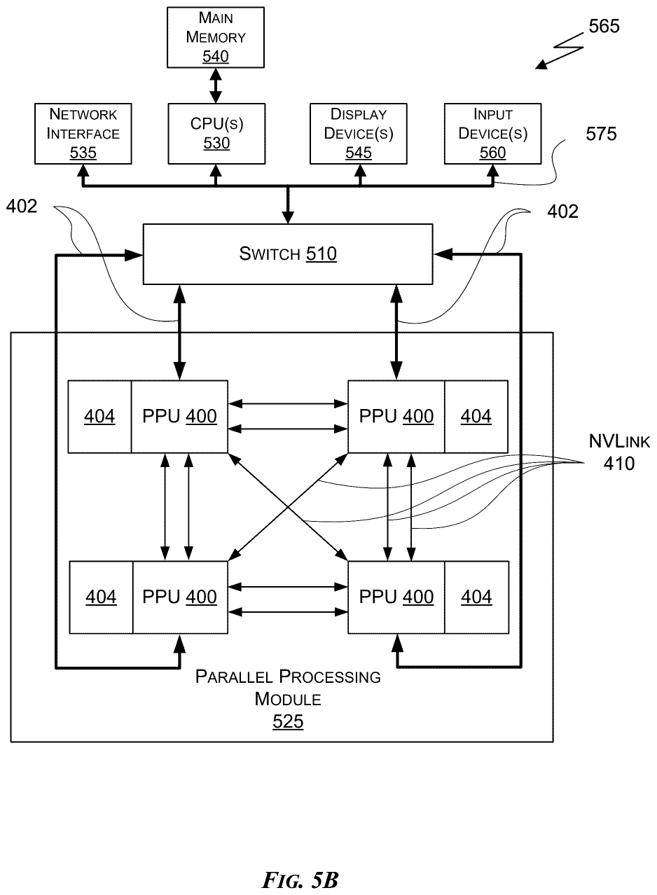

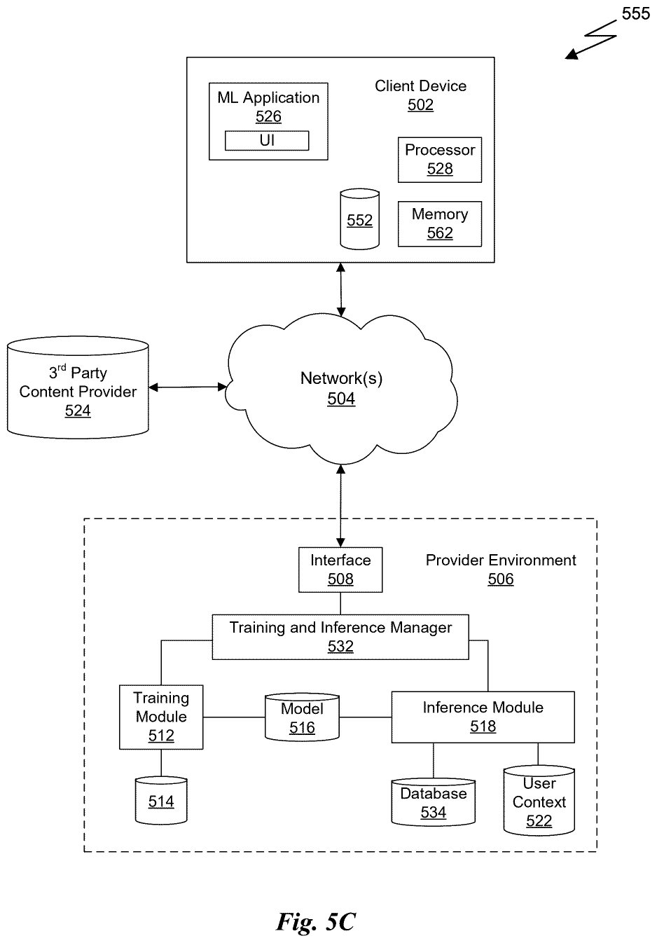

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventionalGDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in an L2 cache, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A illustrates a processing system 500 implemented using the PPU 400 of FIG. 4, according to at least one embodiment. The example system 500 may be used as a component of one or more embodiments of one or more systems disclosed herein or may be used to implement one or more embodiments of one or more systems and methods disclosed herein. The processing system 500 includes a CPU 530, switch 510, and multiple PPUs 400, and respective memories 404. The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an example system 565 in which the various architecture and/or functionality of the various previous embodiments may be implemented, according to at least one embodiment. The example system 565 may be used as a component of one or more embodiments of one or more systems disclosed herein or may be used to implement one or more embodiments of one or more systems and methods disclosed herein. As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5B are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5B is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5B.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or example system 565 of FIG. 5B—e.g., each device may include similar components, features, and/or functionality of the processing system 500 and/or example system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5A and/or example system 565 of FIG. 5B. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates an example system 555 that can be used to train a machine learning model, according to at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

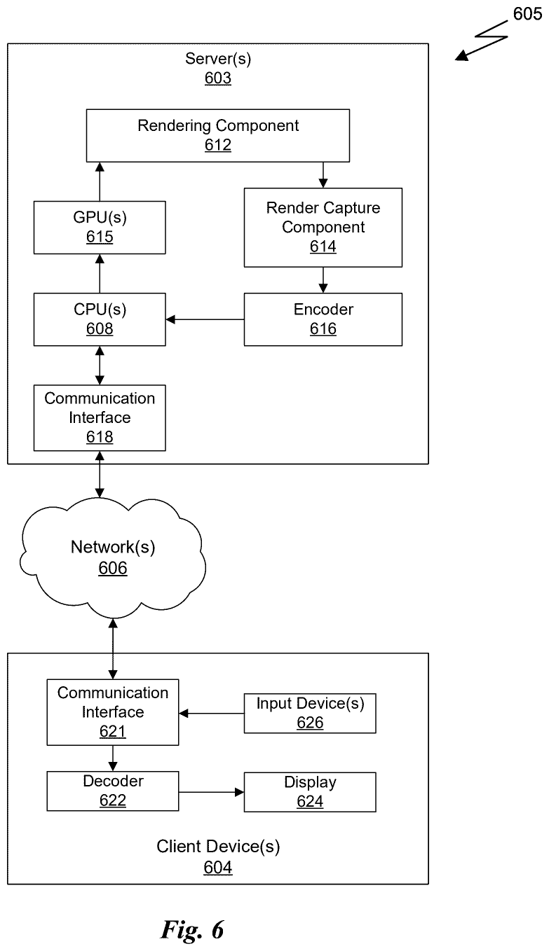

FIG. 6 illustrates an example streaming system 605, according to at least one embodiment. FIG. 6 includes server(s) 603 (which may include similar components, features, and/or functionality to the example processing system 500 of FIG. 5A and/or example system 565 of FIG. 5B), client device(s) 604 (which may include similar components, features, and/or functionality to the example processing system 500 of FIG. 5A and/or example system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

One or more embodiments of the disclosure may be described in the general context of computer code or machine-useable instructions, including computer-executable instructions such as program modules, being executed by a computer or other machine. Generally, program modules, e.g., including routines, programs, objects, components, data structures, etc., refer to code that performs particular tasks or implements particular data types. One or more embodiments of the disclosure may be practiced in a variety of system configurations, including, e.g., hand-held devices, consumer electronics, general-purpose computers, more specialty computing devices, etc. One or more embodiments of the disclosure may also be practiced in distributed computing environments where tasks are performed by remote-processing devices that are linked through a communications network.

Operations of processes described herein can be performed in any suitable order unless otherwise explicitly indicated herein or otherwise clearly contradicted by context. In at least one embodiment, a process, such as described herein (or variations and/or combinations thereof), is performed under control of one or more computer systems configured with executable instructions and is implemented as code (e.g., executable instructions, one or more computer programs, or one or more applications) executing collectively on one or more processors. In at least one embodiment, code is stored on computer-readable storage media, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, computer-readable storage media comprises multiple non-transitory computer-readable storage media, and one or more individual non-transitory storage media of the multiple non-transitory computer-readable storage media lack all code while the multiple non-transitory computer-readable storage media collectively store all of code. In at least one embodiment, executable instructions are executed such that different instructions are executed by different processors—for example, non-transitory computer-readable storage media store instructions and a main central processing unit (“CPU”) executes some of the instructions while a graphics processing unit (“GPU”) executes others of the instructions. In at least one embodiment, different components of a computer system have separate processors and different processors execute different subsets of instructions.

In at least one embodiment, as a result of processing an instruction retrieved by the processor, the processor presents one or more inputs or operands to an arithmetic logic unit (ALU), causing the ALU to produce a result based at least in part on an instruction code provided to inputs of the arithmetic logic unit. In at least one embodiment, the instruction codes provided by the processor to the ALU are based at least in part on the instruction executed by the processor. In at least one embodiment, combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term “arithmetic logic unit,” or “ALU,” may be used to refer to any computational logic circuit that processes operands to produce a result. For example, in the present document, the term ALU can refer to a floating point unit, a digital signal processor (DSP), a tensor core, a shader core, a coprocessor, or a CPU. In at least one embodiment, an ALU is a set of combinational logic circuitry that takes one or more inputs to produce a result. In at least one embodiment, an ALU is used by a processor to implement mathematical operation such as addition, subtraction, or multiplication. In at least one embodiment, an ALU is used to implement logical operations such as logical AND/OR or XOR. In at least one embodiment, an ALU is stateless, and made from physical switching components such as semiconductor transistors arranged to form logical gates. In at least one embodiment, an ALU may operate internally as a stateful logic circuit with an associated clock. In at least one embodiment, an ALU may be constructed as an asynchronous logic circuit with an internal state not maintained in an associated register set. In at least one embodiment, an ALU is used by a processor to combine operands stored in one or more registers of the processor and produce an output that can be stored by the processor in another register or a memory location.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as systems may embody one or more methods and methods may be considered a system.

Use of any and all examples, or exemplary language (e.g., “such as”) provided herein, is intended merely to better illuminate embodiments of the disclosure and does not pose a limitation on scope of disclosure unless otherwise explicitly stated. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In the description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but still co-operate or interact with each other.

Unless specifically stated otherwise, it may be appreciated that throughout the specification terms such as “processing,” “computing,” “calculating,” “determining,” or the like, refer to action and/or processes of a computer or computing system, or similar electronic computing device, that manipulate and/or transform data represented as physical, such as electronic, quantities within registers and/or memories into other data similarly represented as physical quantities within memories, registers or other such information storage, transmission, or display devices.

In the present the document, references may be made to obtaining, acquiring, receiving, or inputting analog or digital data into a subsystem, computer system, or computer-implemented machine. In at least one embodiment, processes of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances. In addition, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

Use of terms “a” and “an” and “the” and similar referents in context of describing disclosed embodiments (especially in context of the following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within a range, unless otherwise indicated herein, and each separate value is incorporated into the specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B or C,” unless specifically stated otherwise or otherwise clearly contradicted by context, is understood with context as used in general to present that an item, term, etc., may be either A or B or C, or any nonempty subset of set of A and B and C. For instance, in illustrative an example of a set having three members, conjunctive phrases “at least one of A, B, and C” and “at least one of A, B or C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more, e.g., when so indicated either explicitly or by context. Further, unless stated otherwise or otherwise clear from context, the phrase “based on” means “based at least in part on” and not “based solely on.”

The foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. For example, the phrase “based on” is intended to mean “based at least in part on” and not “based solely on.” No language in the specification should be construed as indicating any non-claimed element as essential to the practice of the invention as claimed.

What is claimed is:

1. A method for obtaining a robot control policy, comprising:
training a first policy to generate an action sequence based on a reference demonstration that provides, for one or more time steps, reference states of a human hand and an object, the training comprising:
obtaining the reference demonstration;
generating, by the first policy for the one or more time steps, a sequence of actions for controlling a robot end effector to interact with the object;
computing, based on the sequence of actions and the reference states, one or more rewards, wherein the rewards are computed based on a mapping between an anatomy of the human hand and an anatomy of the robot end effector and one or more spatial envelopes for one or more anatomical components of the robot end effector; and
updating parameters of the first policy based on the one or more rewards; and
training, using the first policy, a second policy to generate robot actions based on perception data.

2. The method according to claim 1, wherein training the first policy further comprises:
receiving initial states of the robot end effector and object corresponding to the reference demonstration; and
initializing the robot end effector and the object using the initial states.

3. The method according to claim 1, wherein the first policy is trained over a plurality of episodes to generate a plurality of action sequences based on the reference demonstration, and wherein at the start of each episode of the plurality of episodes, the robot end effector and the object are initialized using the initial states.

4. The method according to claim 3, wherein one or more episodes of the plurality of episodes are terminated, wherein each terminated episode is terminated when the one or more rewards satisfy one or more early termination conditions.

5. The method according to claim 4, wherein, in at least one episode of the plurality of episodes, the one or more early termination conditions are initialized with a large value and adaptively tightened during training.

6. The method according to claim 1, wherein the one or more rewards comprise a state-reference matching reward and an energy regularization reward, wherein the state-reference matching reward corresponds to kinematic state matching based on distances between the robot end effector and the object and one or more tactile indicators corresponding to contacts between the robot end effector and the object, and wherein the energy regularization reward corresponds to smoothness of robotic motions induced by the first policy.

7. The method according to claim 1, wherein training the first policy further comprises:
obtaining, for the one or more time steps, one or more states of the robot end effector and the object by applying the sequence of actions to control the robot end effector,
wherein computing the one or more rewards is further based on the one or more states of the robot end effector and the object and the reference states at the one or more time steps.

8. The method according to claim 1, wherein the perception data comprises a partial observation of the robot end effector and the object and a predefined goal that defines a robot manipulation task.

9. The method according to claim 1, wherein the second policy is learned by a model comprising a prior network configured to encode the perception data to sample a latent representation from a latent space and a decoder network configured to decode the sampled latent representation into an action sequence.

10. The method according to claim 9, wherein training the second policy comprises:
encoding, using an encoder, a plurality of reference demonstrations to produce a reference latent space comprising a plurality of latent representations, the reference latent space associated with a reference latent representation distribution, wherein each latent representation from the reference latent space corresponds to a reference trajectory;
generating, by the first policy, a reference action sequence corresponding to a given reference trajectory;
sampling, using the prior network and based on the perception data, a latent representation from a latent space of the prior network, wherein during training, the latent space of the prior network is compensated using the reference latent representation distribution of the reference latent space;
decoding, using the decoder network, the sampled latent representation to generate a predicted action sequence;
computing a loss between the reference action sequence and the predicted action sequence; and
updating the encoder network, the prior network, and the decoder network by minimizing the loss, and by aligning the reference latent space with the latent space of the prior network.

11. The method according to claim 1, wherein the reference demonstration is provided by a hand-object motion-capture (MoCap) dataset.

12. The method according to claim 1, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially in a data center;
a system implemented at least partially using cloud computing resources;
a system using or deploying one or more inference microservices; or
a system that incorporates one or more machine learning models deployed in a service or microservice along with an OS-level virtualization package (e.g., a container).

13. A system for obtaining a robot control policy, comprising:
one or more processors configured to:
train a first policy to generate an action sequence based on a reference demonstration that provides, for one or more time steps, reference states of a human hand and an object, the training comprising:
obtaining the reference demonstration;
generating, by the first policy for the one or more time steps, a sequence of actions for controlling a robot end effector to interact with the object;
computing, based on the sequence of actions and the reference states, one or more rewards, wherein the rewards are computed based on a mapping between an anatomy of the human hand and an anatomy of the robot end effector and one or more spatial envelopes for one or more anatomical components of the robot end effector; and
updating parameters of the first policy based on the one or more rewards; and
train, using the first policy, a second policy to generate robot actions based on perception data.

14. The system according to claim 13, wherein training the first policy further comprises:
receiving initial states of the robot end effector and object corresponding to the reference demonstration; and
initializing the robot end effector and the object using the initial states,
wherein the first policy is trained over a plurality of episodes to generate a plurality of action sequences based on the reference demonstration, and wherein at the start of each episode of the plurality of episodes, the robot end effector and the object are initialized using the initial states.

15. The system according to claim 14, wherein one or more episodes of the plurality of episodes are terminated, wherein each terminated episode is terminated when the one or more rewards satisfy one or more early termination conditions,
wherein, in at least one episode of the plurality of episodes, the one or more early termination conditions are initialized with a large value and adaptively tightened during training.

16. The system according to claim 13, wherein the one or more rewards comprise a state-reference matching reward and an energy regularization reward, wherein the state-reference matching reward corresponds to kinematic state matching based on distances between the robot end effector and the object and one or more tactile indicators corresponding to contacts between the robot end effector and the object, and wherein the energy regularization reward corresponds to smoothness of robotic motions induced by the first policy.

17. The system according to claim 13, wherein the second policy is learned by a model comprising a prior network configured to encode the perception data to sample a latent representation from a latent space and a decoder network configured to decode the sampled latent representation into an action sequence.

18. The system according to claim 17, wherein training the second policy comprises:
encoding, using an encoder, a plurality of reference demonstrations to produce a reference latent space comprising a plurality of latent representations, the reference latent space associated with a reference latent representation distribution, wherein each latent representation from the reference latent space corresponds to a reference trajectory;
generating, by the first policy, a reference action sequence corresponding to a given reference trajectory;
sampling, using the prior network and based on the perception data, a latent representation from a latent space of the prior network, wherein during training, the latent space of the prior network is compensated using the reference latent representation distribution of the reference latent space;
decoding, using the decoder network, the sampled latent representation to generate a predicted action sequence;
computing a loss between the reference action sequence and the predicted action sequence;
updating the encoder network, the prior network, and the decoder network by minimizing the loss, and by aligning the reference latent space with the latent space of the prior network.

19. A non-transitory computer-readable media storing computer instructions for obtaining a robot control policy that, when executed by one or more processors, cause the one or more processors to perform:
training a first policy to generate an action sequence based on a reference demonstration that provides, for one or more time steps, reference states of a human hand and an object, the training comprising:
obtaining the reference demonstration;
generating, by the first policy for the one or more time steps, a sequence of actions for controlling a robot end effector to interact with the object;
computing, based on the sequence of actions and the reference states, one or more rewards, wherein the rewards are computed based on a mapping between an anatomy of the human hand and an anatomy of the robot end effector and one or more spatial envelopes for one or more anatomical components of the robot end effector; and
updating parameters of the first policy based on the one or more rewards; and
training, using the first policy, a second policy to generate robot actions based on perception data.

20. The non-transitory computer-readable media according to claim 19, wherein the first policy is trained over a plurality of episodes to generate a plurality of action sequences based on the reference demonstration, wherein one or more episodes of the plurality of episodes are terminated, wherein each terminated episode is terminated when the one or more rewards satisfy one or more early termination conditions, and wherein, in at least one episode of the plurality of episodes, the one or more early termination conditions are initialized with a large value and adaptively tightened during training.
